(19) United States
(12) Patent Application Publication
(10) Pub. No.: US 2011/0078346 A1
(43) Pub. Date: Mar. 31, 2011

(54) Computer Networking Device and Method Thereof

(76) Inventors: Michael O'Connor, Saratoga Springs, NY (US); Victor Sevilla, Delmar, NY (US); Douglas Engel, Scotia, NY (US); Robert Dvorak, Saugerties, NY (US); Michael Turiel, Clifton Park, NY (US)

(21) Appl. No.: 12/567,911

(22) Filed: Sep. 28, 2009

(51) Int. Cl. G06F 13/12

(52) U.S. Cl. 710/63

(57) ABSTRACT

A universal computer networking device, in particular an Ethernet switch and the like, comprising a computer networking device having more than one power connection located on the computer networking device, wherein the computer networking device connects to a power source from either a first side or a second side of the computer networking device. Also, a method providing a computer networking device having more than one power connection located on the computer networking device, wherein the computer networking device connects to a power source from either a first side or a second side of the computer networking device, and attaching a power source to a first opening located proximate the first side of the computer networking device or to the second opening located proximate a second side of the computer networking device. Also, a device which contains Copper RJ45 transceiver ports and fiber-optic transceiver ports on the same switch. Additionally, a device and method of performing a high potential voltage test to an electronic device without major disassembly. Lastly, a device and method to transfer heat away from a heat-emitting component located within an electronic device, and in particular, a computer networking device.

### BACKGROUND OF THE INVENTION

1. Field of the Invention

The present invention relates to a device and method for a universal computer networking device, in particular, an Ethernet switch and the like.

2. Related Art

Rack switches designed for rack mount cages are, generally, either front wired or rear wired. For example, in a typical server room, a rack switch has Ethernet ports and brackets on the front of the rack switch and the power connection in the back of the rack switch. This type of arrangement is known as front wired. Conversely, in other applications, the rack switch has Ethernet ports and the power connection on the back of the rack switch. This type of arrangement is known as rear-wired mount, or reverse-wired mount. Because rack switches are designed as either front wired or rear wired, manufacturers build the rack switches either front-wired or rear-wired. Furthermore, consumers must decide whether to purchase a front wired or rear wired rack switch before completely knowing whether they want to employ a front wired or rear wired rack mount cage, and consumers cannot change the arrangement of the rack switches or the rack switch mount cage without purchasing new rack switches. Additionally, manufactures and distributors must stock both types of rack switches.

Thus, there is a need for a device and method which overcomes the aforementioned deficiencies in the art by providing a universal computer networking device, in particular an Ethernet switch, which may be either front wired or rear wired, without major disassembly.

There is also a need for a device which contains Copper RJ45 transceiver ports and fiber-optic transceiver ports on the same switch, and in particular, an industrial or ruggedized computer networking device.

There is also a need for a device and method of performing a high potential voltage test to an electronic device, in particular, a computer networking device, without major disassembly, while ensuring the system integrity.

Additionally, there is a need for a device and method to transfer heat away from a heat-emitting component located within an electronic device, and in particular, a computer networking device.

### SUMMARY OF THE INVENTION

A first aspect of the present invention provides a device comprising a computer networking device having more than one power connection located on said computer networking device, wherein said computer networking device connects to a power source from either a first side or a second side of said computer networking device.

A second aspect of the present invention provides a universal computer networking device comprising a first opening located proximate a first side of a chassis, said first opening receptive to a power source; a second opening located proximate a second side of said chassis, said second opening receptive to a power source.

A third aspect of the present invention provides a method of making a computer networking device universal comprising providing a computer networking device having more than one power connection located on said computer networking device, wherein said computer networking device connects to a power source from either a first side or a second side of said computer networking device; and attaching a power source to a first opening located proximate said first side of said computer networking device or to said second opening located proximate a second side of said computer networking device.

A fourth aspect of the present invention provides a device comprising a plurality of small form factor pluggable ports located on a chassis, said ports being receptive to both a removable copper transceiver and a removable fiber-optic transceiver; wherein an arrangement of said removable copper transceiver and said removable fiber-optic transceiver includes an adjustable ratio of said removable copper transceivers to said removable fiber-optic transceivers.

A fifth aspect of the present invention provides a device comprising a computer networking device having an opening on a face of said computer networking device, wherein said opening allows access inside said computer networking device; a conductive resilience member, located within said computer networking device, contacting a surface of said computer networking device, wherein contact between said conductive resilience member and said surface establish an electrical connection; and wherein an insulator engages said conductive resilience member, breaking said electrical connection.

A sixth aspect of the present invention provides a device comprising an electrical circuit with a local common connection, said common connection being electrically common to a ground; a spring member in electrical communication to said common connection, wherein an opposite end of said spring member is in mechanical communication with said earth ground, establishing an electrical communication between said spring member and said ground; a slot providing access to said spring members, wherein a dielectric element inserted through said slot breaks said electrical communication.

A seventh aspect of the present invention provides a method of performing a high potential test comprising: providing a computer networking device having an opening on a face of said computer networking device, wherein said opening allows access inside said computer networking device, and a conductive resilience member located within said computer networking device, contacting a surface of said computer networking device, wherein contact between said conductive resilience member and said surface establish an electrical connection; positioning an insulator between said conductive resilience member and said surface of said computer networking device to break said electrical connection; sending a high amount of voltage into said computer networking device to test an internal circuit system; and removing said insulator.

### BRIEF DESCRIPTION OF THE DRAWINGS

Some of the embodiments of this invention will be described in detail, with reference to the following figures, wherein like designations denote like members wherein:

FIG. 1 depicts a front view of an embodiment of a universal computer networking device with a power plug inserted into a power receptacle;

FIG. 1A depicts a front view of an embodiment of a universal computer networking device with a protective plate placed over a power receptacle;

FIG. 1B depicts a front view of an embodiment of a universal computer networking device without a power plug inserted and no protective plate placed over power receptacle;

FIG. 2 depicts a rear view of an embodiment of a universal computer networking device with a power plug inserted into a power receptacle;

FIG. 2A depicts a rear view of an embodiment of a universal computer networking device with a protective plate placed over a power receptacle;

FIG. 2B depicts a rear view of an embodiment of a universal computer networking device without a power plug inserted and no protective plate placed over power receptacle;

FIG. 3 depicts a top view of an embodiment of a universal computer networking device;

FIG. 4 depicts a perspective view of an embodiment of a universal computer networking device;

FIG. 5 depicts a top view of an embodiment of a universal computer networking device bracket system and a multitude of variations and orientations;

FIG. 6 depicts a perspective view of an embodiment of a switch having a number of small form factor pluggable ports;

FIG. 7 depicts a perspective view of an embodiment of a SFP Fiber Transceiver and a SFP Copper Transceiver;

FIG. 8 depicts a perspective view of an embodiment of a switch having an assortment of SFP copper and fiber transceivers;

FIG. 9 depicts a perspective view of an embodiment of a computer networking device having a high potential slot located thereon;

FIG. 10 depicts a horizontal cross-section of an embodiment of a computer networking device having a high potential slot located thereon;

FIG. 11 depicts a side, cross-section view of an embodiment of a computer networking device having a high potential slot during normal operating conditions;

FIG. 12 depicts a side, cross-section view of an embodiment of a computer networking device having a high potential slot during a high potential test;

FIG. 13 depicts a schematic of an embodiment of a circuitry during normal operating conditions;

FIG. 14 depicts a schematic of an embodiment of a circuitry during a high potential test;

FIG. 15 depicts a cross-section view of an embodiment of a heat conduction system inside a network chassis;

FIG. 16 depicts a cross-section view of an embodiment of a heat conduction system inside a computer networking device, wherein heat is transferred away from a heat component.

### DETAILED DESCRIPTION OF THE DRAWINGS

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

The present invention may relate to any computer networking device, such as a network switch. In one embodiment, the present invention relates to an Ethernet switch. In another embodiment, the present invention relates to a ruggedized, hardened, or industrial grade switch. In other embodiments, the present invention may relate to a gateway, router, bridge, switch, hub, repeater, multilayer switch, protocol converter, switch mount, bridge router, digital media server, multiplexer, modem, ISDN terminal adapter, line driver and the like. For ease of explanation, the term computer networking device shall be used throughout the detailed description, but may refer to any one of the computer networking devices listed above.

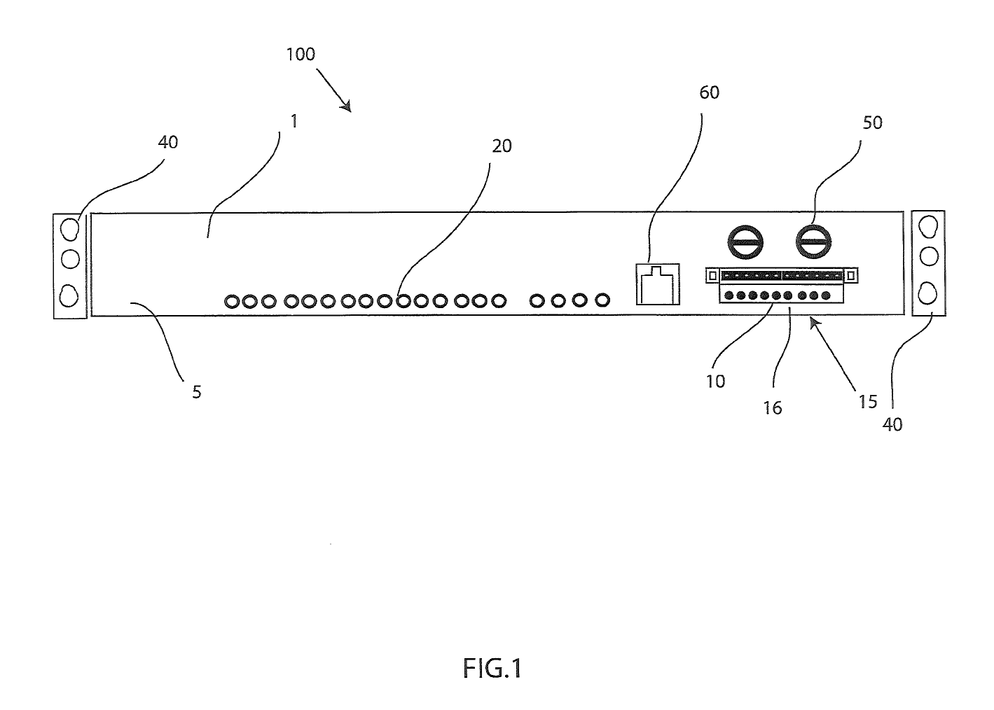

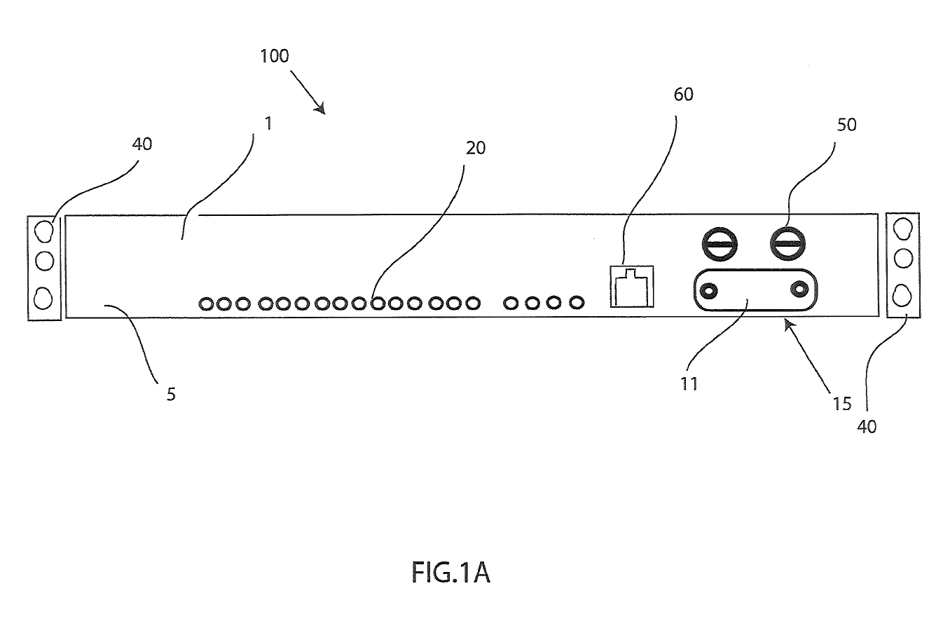

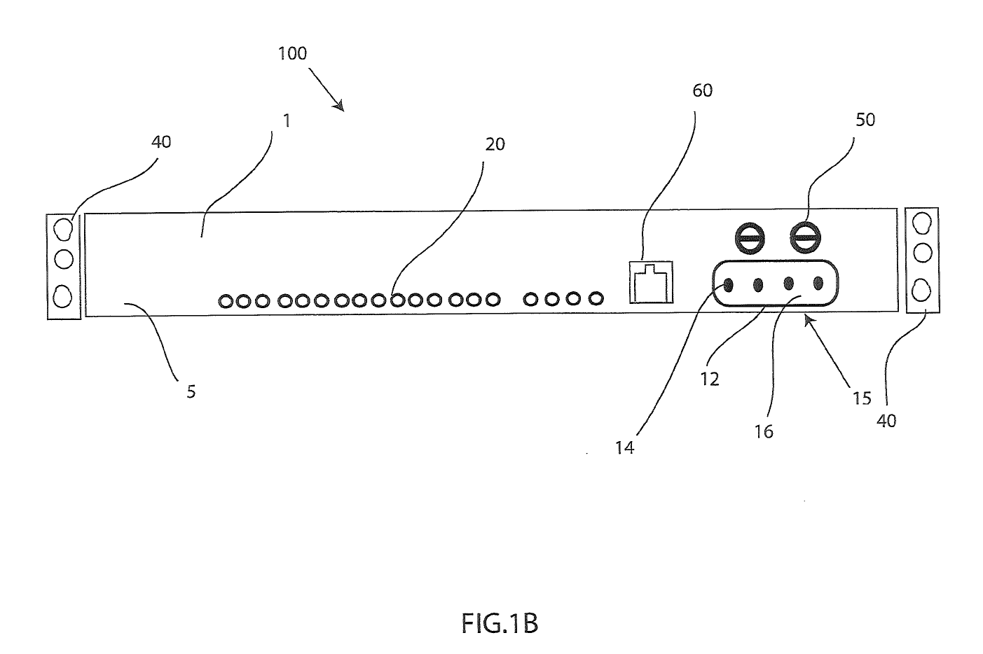

FIG. 1 depicts an embodiment of a first side 1 universal computer networking device 100, which may have a multitude of components such as brackets 40, LEDs 20, a console port 60, a chassis ground point 50, a power plug 10, and a first power receptacle 16. As shown in FIG. 1A, first side 1 may include a power receptacle cover 11 placed over a power receptacle when no power plug 10 is present, wherein the power plug 10 is potentially attached on second side 2. FIG. 1B depicts an embodiment of a universal computer networking device 100 wherein no power plug 10 is inserted into a first receptacle 16, and no power receptacle cover 11 is placed over a first power receptacle 16; thus, the inside of a power receptacle 12 and a set of mating pins 14 may be exposed. More than one console port 60, more than one chassis ground point 50, and at least one bracket 40 may be affixed, located, mounted, or positioned on the first side 1. The arrangement of the components on the first side 1 of the universal computer networking device 100 may vary. For example, the location of the console port 60 may be different than its location depicted on FIG. 1, and also true for the rest of the components. Accordingly, the arrangement of the components on the first side 1 of the universal computer networking device 100 depicted by FIG. 1 should not limit the present invention in that respect. The height, width, and depth of the universal computer networking device 100 may also vary, and generally may be dimensioned to fit inside a typical rack mount cage. In one exemplary embodiment, the universal computer networking device 100 is approximately 17″-18″ wide. In another embodiment, the universal computer networking device 100 may be approximately 18″-20″ wide. In yet another embodiment, the universal computer networking device 100 is approximately 20″-24″ wide. It is understood that the size of the universal computer networking device 100 may vary with the size of a rack mount cage. Furthermore, the universal computer networking device 100 need not be placed in a rack cage mount, and may be stacked one on top of the other, may be placed side by side, or may be arranged in any fashion.

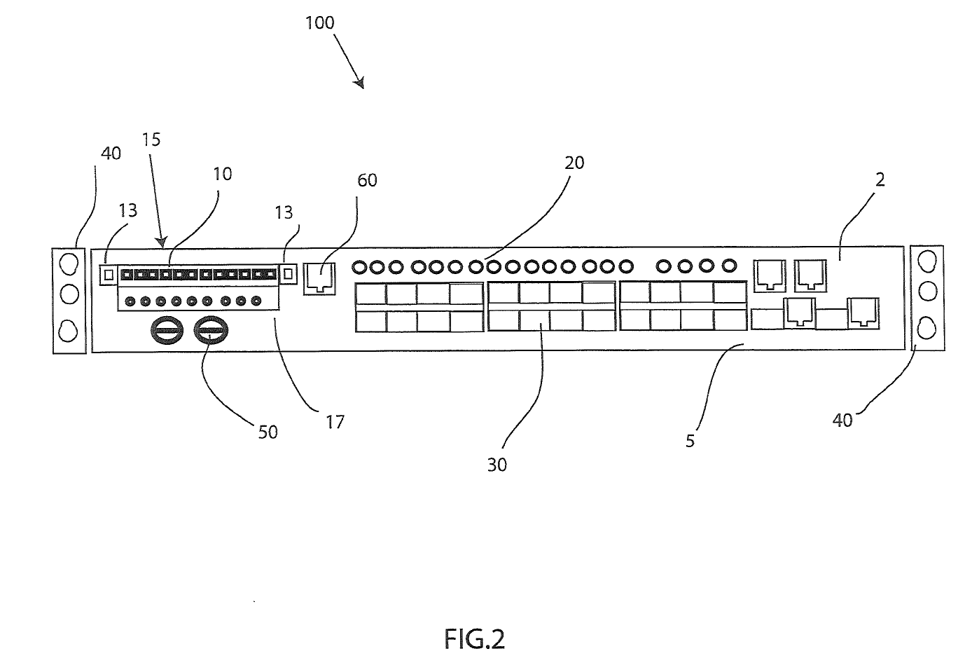

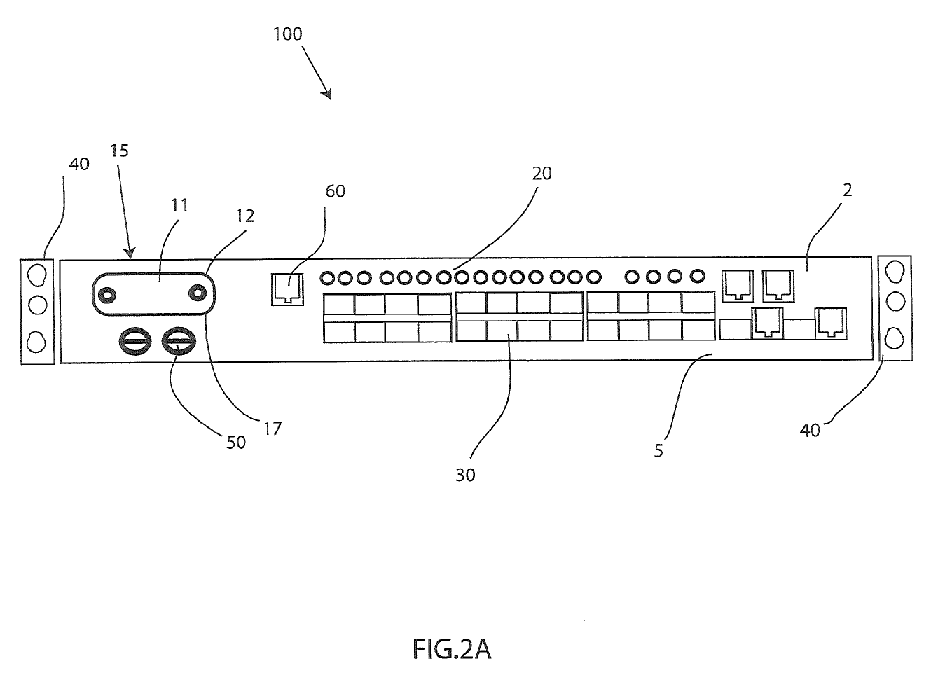

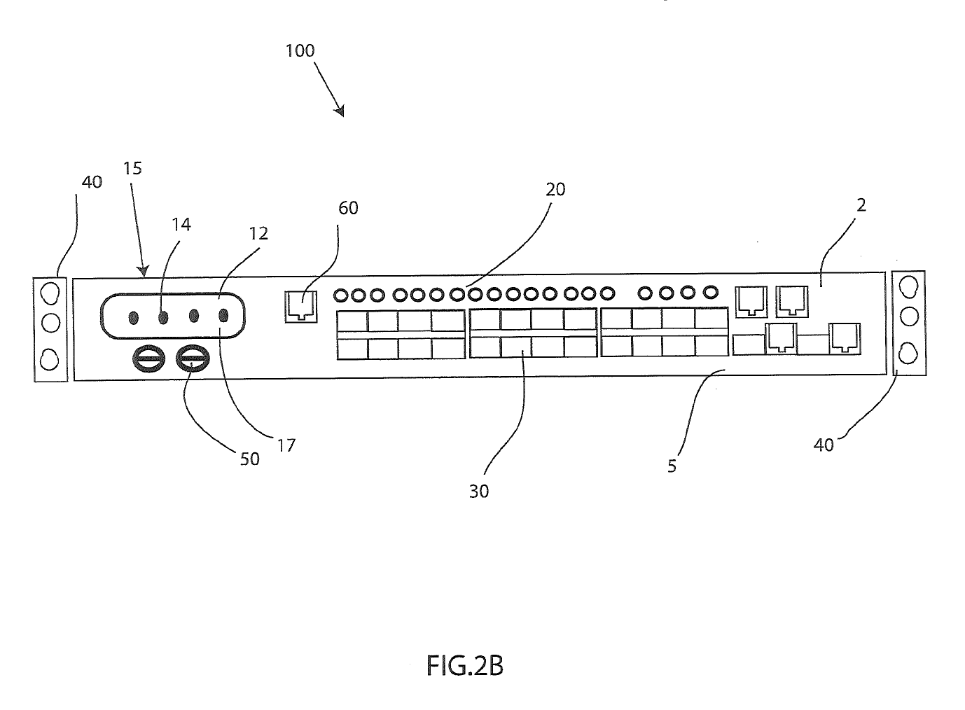

FIG. 2 depicts a second side 2 of a universal computer networking device 100 having Ethernet ports 30, a console port 60, a power plug 10 inserted into a second power receptacle 17, at least one chassis ground point 50, at least one bracket 40, and LEDs 20. As shown in FIG. 2A, second side 2 may include a power receptacle cover 11 placed over a second power receptacle 17 when no power plug 10 is present, the power plug 10 possibly attached on first side 1. FIG. 2B depicts an embodiment of a universal computer networking device 100 wherein no power plug 10 is inserted into a second receptacle 17, and no power receptacle cover 11 is placed over a second power receptacle 17; thus, the inside of a power receptacle 12 and a set of mating pins 14 may be exposed. The arrangement of the components on the second side 2 of the universal computer networking device 100 may vary. For example, the location of the console port 60 may be different than its location depicted on FIG. 2, and also true for the rest of the components. Accordingly, the arrangement of the components on the second side 2 of the universal computer networking device 100 depicted by FIG. 2 should not limit the present invention in that respect. The Ethernet ports 30 may be any Ethernet ports known to those having skill in the art. The console port 60 may be a serial RS232 port, or any like port. The LEDs 20 may also be standard light emitting diodes, and may be used as indicator lights, or may be used for any purpose or function known to those skilled in the art. The chassis grounding points 50 may be any safety-ground connection.

Therefore, the universal computer networking device 100, or network switch 100, may have LEDs 20, a console port 60, chassis ground points 50, mounting brackets 40 and a power connection 15 on both the first side 1 and the second side 2. Ostensibly, the universal computer networking device 100 may have the ability to change mounting orientations in a rack mount by removing a power plug 10 from a second receptacle 17 and inserting the power plug 10 into a first receptacle 16, or vice versa. Because LEDs 20, console ports 60, and chassis ground points 50 may be located on both sides 1, 2, the universal computer networking device 100 may function regardless of what side the power plug is affixed. In most embodiments, the Ethernet ports 30 may only be located on the second side 2, but may be manufactured having Ethernet ports 30 on the first side 1.

The power connection 15 may comprise a power plug 10, a power receptacle 12, at least one screw terminal block 13, a set of mating pins 14, and a power receptacle cover 11. The power connection 15 may be located somewhere on the first side 1, somewhere on the second side 2 of the universal computer networking device 100, or may be located on both the first side 1 and the second side 2 simultaneously. In other words, a power connection 15 may be present on the front (e.g. first side 1) and back (e.g. second side 2) of the universal computer networking device 100. The power connection 15 may not always comprise a power plug 10, and may not always comprise a power receptacle cover 11 on the same side of the universal computer networking device 100. For example, the power connection 15 located on the first side 1 may comprise a power plug 10 inserted within a power receptacle 12 (See FIG. 1), while on the second side 2 the power connection 15 may comprise an empty power receptacle 12 with the opening covered by the power receptacle cover 11 (See FIG. 2A). In one embodiment, the power connection 15 located on the first side 1 will have a detachable power plug 10 installed in the power receptacle 12. In another embodiment, the power connection 15 located on the second side 2 will have a detachable power plug 10 installed in the power receptacle 12.

Moreover, the power source standards used by the universal computer networking device 100 may be compatible with the North American standard of 110-120 Volts at a frequency of 60 Hz, the European standard of 220-240 Volts at a frequency of 50 Hz, and combinations thereof. Thus, the size, the shape, and the connectors of the power receptacle 12 and the power plug 10 may vary depending on the standards of the particular place of operation.

Furthermore, the power plug 10 may be removable, swappable, detachable, separable, etc., from the power receptacle 12. The power plug 10 may be a plug, a pluggable unit, a pluggable terminal block, a power block, a power unit, a power connector, and may have female mating pins with front wire actuation and locking flanges. Standard, or custom designed, power wires may be attached to the power plug 10 to power the universal computer networking device 100. For example, once the power plug 10 is removably secured into a first power receptacle 16 or a second power receptacle 17, a user may attach power wires to the power plug. For example, the power plug 10 may be detached from the first side 1 and re-located to the second side 2 of the universal computer networking device 100 without major disassembly; disassembly may not be required all together. Thus, a consumer may have a universal computer networking device 100 with Ethernet ports 30 on the second side 2, and choose to inject the power plug 10 to the first side 1 of the universal computer networking device 100, thus drawing power from the first side 1. Moreover, if that same consumer later changes his or her mind, or redesigns a substation or server room, the power plug 10 may simply be detached and re-located to the power receptacle 12 located on the second side 2 to allow the universal computer networking device 101 to draw its power from the second side 2. The power receptacle cover 11 may also be removable, detachable, separable, etc. from the chassis 5 to allow the power plug 10 to be inserted into or removed from the power receptacle 12. The power receptacle cover 11 may be removably attached to the chassis 5 by screws and the like, or any hardware known to those skilled in the art.

Having a power connection 15 on both sides of the universal computer networking device 100 may present many advantages because it may not matter whether the switch is front-wired or rear-wired at the point of manufacture. In other words, the same universal computer networking device 100 may be either front-wired or rear-wired. For example, a common front-wired switch may have Ethernet ports on the front of the switch that hang down in front of a rack mount cage, but does not have a power connection 15 on the front, so the power must be injected into the back of the switch. The universal computer networking device 100 may allow the power supply to be injected into the first side 1 or second side 2, eliminating that constraint. Thus, the universal computer networking device 100 may have Ethernet ports 30 in the back, or second side 2, and may have the power source 10 injected at the front or the back, or first side 1 and second side 2, respectively. Another advantage of the universal computer networking device 100 may be that the manufacturer does not have to build both front-wired and rear-wired switches, but may simply manufacture a universal computer networking device 100. A further advantage of the universal computer networking device 100 may allow the consumer to decide, after delivery of the universal computer networking device 100, whether to employ a front-wired or rear-wired rack mount cage. Additionally, anyone in the field may remove the power plug 10 from first side 1 and attach it to second side 2 without risking any damage to the internal components, the internal arrangement, the connections, or the integrity of the structure of the universal computer networking device 100. Thus, a consumer may change the orientation of the universal computer networking device 100 without the need to send it in to the manufacturer or seek professional repair/disassembly.

In the case of an industrial grade/strength universal computer networking device 101, the ability to swap the power supply from one side of the switch 101 to the other without major disassembly may be a significant enhancement. Industrial, hardened, rugged, or ruggedized universal computer networking devices 101 may be designed to reliably operate in harsh operating environments and conditions, such as extreme heat or extreme cold, electromagnetic noise, electrical spikes and/or surges, power dropouts, high voltage, etc. To reliably operate in these extreme environments and under these conditions, the switch may be sealed, may be designed to be water and moisture resistant, and may be very carefully and meticulously constructed to survive operation in extremely harsh environments. For example, an industrial switch may be sealed to protect against dust and debris, and may be sealed to an Ingress Protection of IP30 or better. Additionally, an industrial grade switch may employ extra power filters and protection for the power receptacles and power inputs, which may be difficult to disassemble and reassemble.

Disassembling and reassembling an industrial grade computer networking device 101 may require a great amount of precision, may compromise the integrity of the switch and may negatively affect the performance of the industrial grade computer networking device 101 when operating in such harsh environments. Moreover, an industrial grade computer networking device 101 may be all metal and may have extra fasteners such as screws, welds, etc. to protect against shock and vibration. For example, disassembling just the cover of an industrial computer networking device 101 may require the removal of 14 screws. In addition to the extra fasteners, an industrial computer networking device 101 may contain various heat sinks and thermal pads which may need to be rearranged when deconstructing the computer networking device. Therefore, the ability to simply swap the detachable power plug 10 from the first side 1 with the power receptacle cover 11 from the second side 2 and connect it to the second side 2, or vice versa, without having to dissemble the universal computer networking device 101 may be a significant enhancement and advantage, as will be appreciated by those skilled in the art.

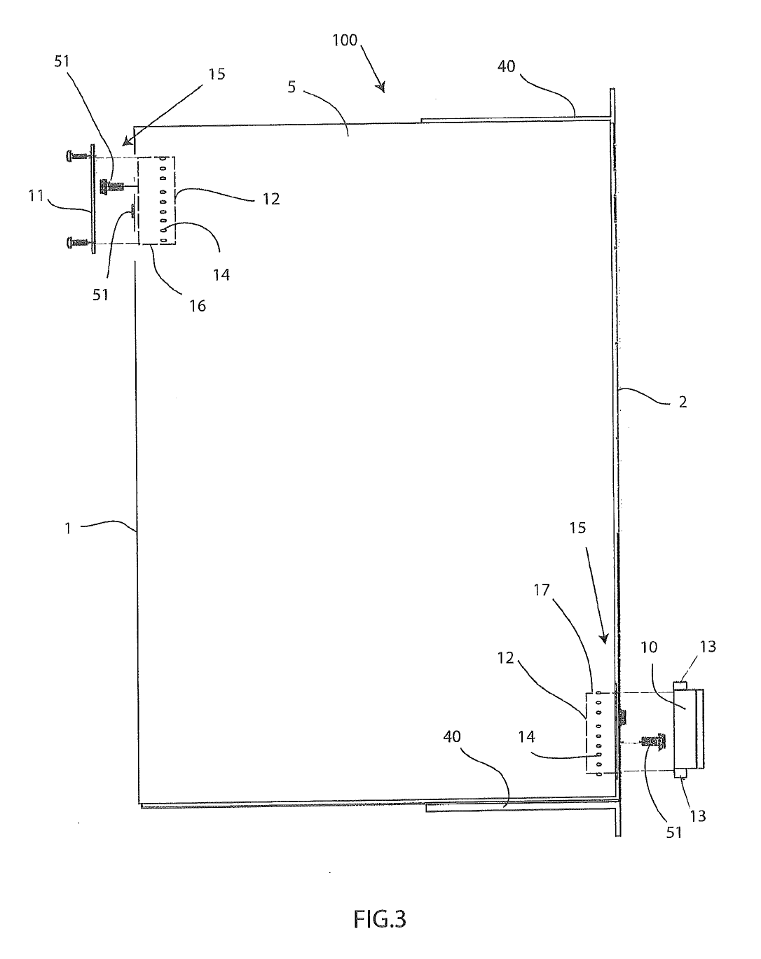

Referring now to FIG. 3, the power receptacle 12 may be located within the chassis 5. In most embodiments, the universal computer networking device 101 may have two power receptacles 12 located on opposite sides from each other. The power receptacle 12 may be an opening, cavity, hollow space, housing, or nook, and may have a set of mating pins 14 which interact, connect, accept, or couple with the power plug 10. The power receptacle 12 may be positioned within the chassis 5, near or proximate the surface of first and second sides 1, 2. Moreover, a first power receptacle 16 may be located within the chassis 5 near the edge of the chassis 5, proximate the surface of the first side 1, and may be receptive to a power plug 10. A second power receptacle 17 may be located within the chassis 5 near the edge of the chassis 5, proximate the surface of second side 2, and may be receptive to a power plug 10. The universal computer networking device 100 may be fully powered by either power connection 15 when a power plug 10 is inserted into the power receptacle 12 and power cables are appropriately attached to the power plug 10. Accordingly, there may be no difference in introducing the power from the first side 1 or from the second side 2, with the exception that there may be additional wiring in the internal body of the universal computer networking device 101.

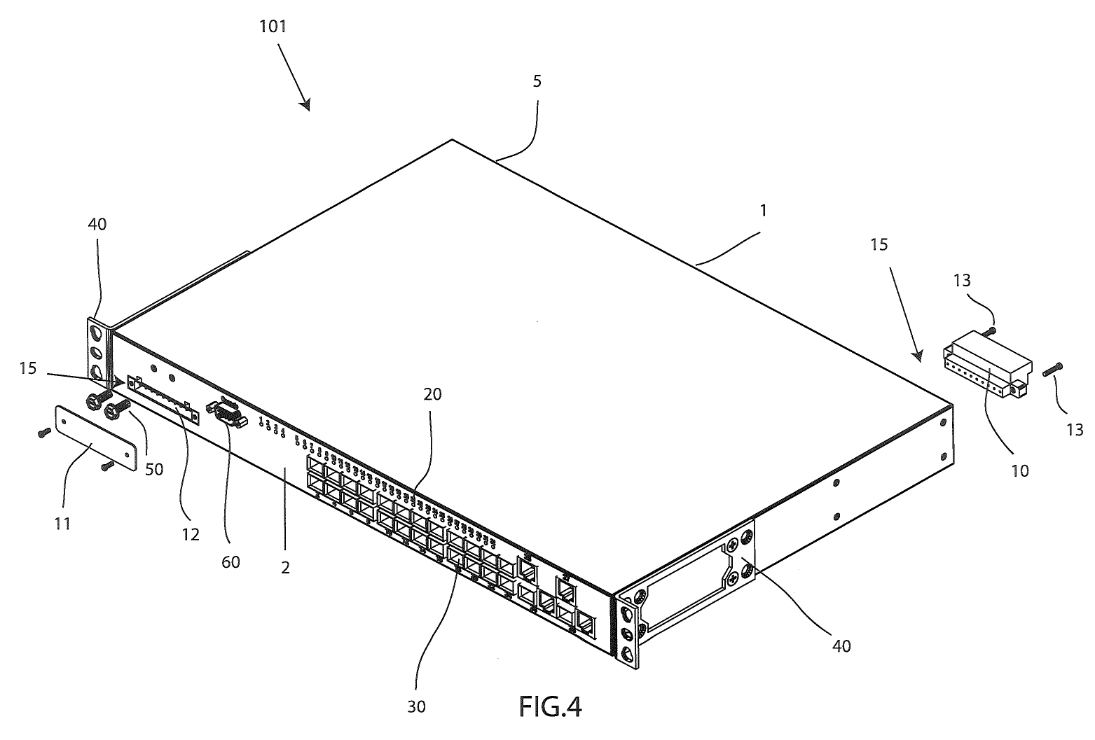

The power receptacle 12 may be dimensioned to accommodate a power plug 10, and may vary in volume. For example, the power receptacle 12 may snugly accommodate a power plug 10, or may maintain a tolerance between the inner walls of the power receptacle 12 and the outer surface of the power plug 10. In one embodiment, the power receptacle 12 may accommodate the power plug 10 such that the power plug 10 may not easily fall out of the power receptacle (i.e. without applying force), but that the power plug 10 may be retrieved, detached, removed, etc., from the power receptacle 12 by applying a relatively small or light force. In another embodiment, the power plug 10 may be removably secured within the power receptacle 12 with the use of screw terminal blocks 13, which may tighten the connection between the power plug 10 and a set of mating pins 14 located within the power receptacle 12 (See FIG. 4).

A set of mating pins 14 may be soldered to a circuit board of the power receptacle 12. Moreover, the set of mating pins 14 may be bent at a right angle, may have locking flanges, and may be any connector configured to accept a power plug 10 of various types known to those skilled in the art. The set of mating pins 14 may be permanently located on the back wall of the power receptacle, as shown in FIG. 3. When a power plug 10 is inserted into a first or second power receptacle 16, 17, the set of male mating pins 14 may interact, couple, accept, mate, or connect with female mating pins located on the power plug 10. The power plug 10 may detach from the set of mating pins 14 after initially connected, and may be attached and reattached depending on what side of the chassis 5 a consumer desires to inject the power plug 10. To establish power coming into the universal mount switch 101, power wires/cables may be attached to the opposite side of the power plug 10 that engages the set of mating pins 14 within the power receptacle 12.

When the power plug 10 is fastened, affixed, attached, connected, mated, placed, etc., in the first receptacle 16, for example, a power receptacle cover 11 may be placed over the opening of the second power receptacle 17, and vice versa. In other words, a power receptacle cover 11 may be placed over the power receptacle 12 that is not occupied by a power plug 10. The power receptacle cover 11 may be a protective plate, cover, guard, shield, lid, or screen, and may be constructed out of the same material as the chassis 5, or may be metal, plastic, ceramic, screen, mesh, or any material that may prevent objects from entering into the unoccupied power receptacle 12. The power receptacle cover 12 may be pliable or rigid. Furthermore, the power receptacle cover 11 may be dimensioned such that it covers, blocks, shields, etc., the opening of the power receptacle 12 when a power plug 10 is not present. In most embodiments, a portion of the power plug 10, when inserted into the power receptacle 12, may extend a distance into the power receptacle 12. In other embodiments, the power plug 10, when inserted into the power receptacle 12, may be flush with the first or second side 1, 2. Furthermore, a power receptacle cover 11 may be placed over the first power receptacle 16 and second power receptacle 17 at the same time if the universal computer networking device 100 is being stored, shipped, delivered, transported, etc., to prevent objects from entering into the power receptacle.

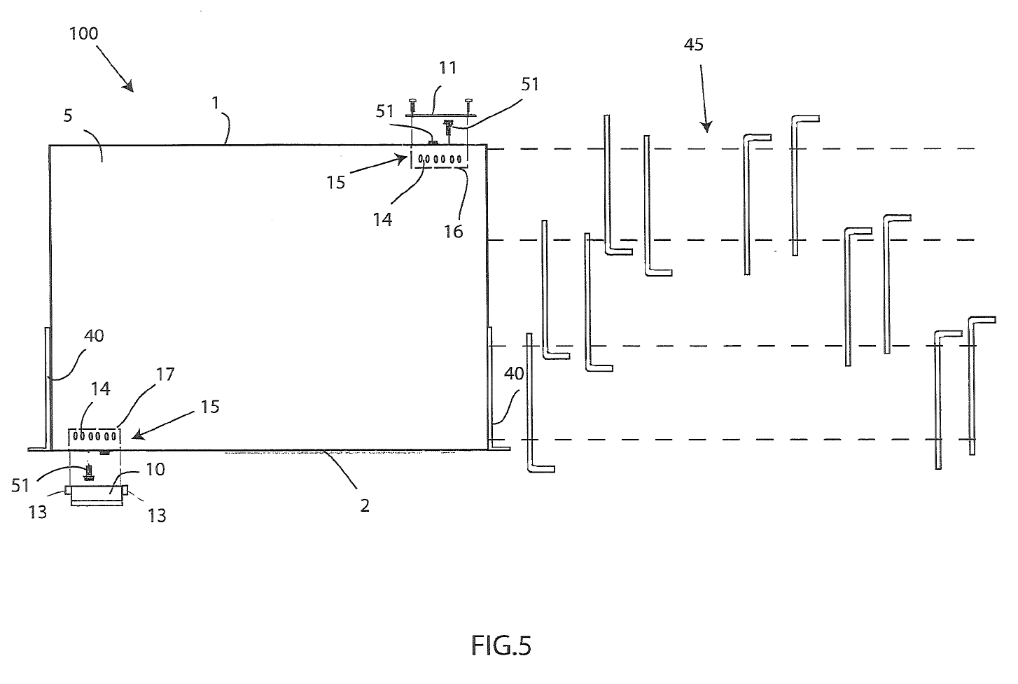

FIG. 5 depicts a multitude of positions wherein a bracket 40 may be fastened to the chassis 5. One or more brackets 40 may be affixed to both sides adjacent to the first and second side 1, 2 of the chassis 5 in a plurality of locations, and may be known as a bracket system 45. Specifically, brackets 40 may be removably fastened to the sides of the chassis 5 directly adjacent to first side 1 and second side 2. FIG. 5 shows an embodiment of bracket positions for only one side of the chassis 5, but it should be understood that the positions shown may reflect the possible positions for the opposite side. Both sides adjacent to first and second sides 1, 2 of the chassis 5 may contain brackets 40. The bracket system 45, including brackets 40 may use a universal EIA/WECO/ETSI mounting hole. In most embodiments, the brackets 40 comprising the bracket system 45 may be used for mounting the universal computer networking device 100 onto a typical rack mount cage. Bracket system 45, with its various positions and orientations, may allow a universal computer networking device 100, an industrial grade computer networking device 101, network switch, chassis 5 to support a multitude of mounting arrangements and/or orientations when being mounted to a structure, such as a rack mount cage.

Because the universal computer networking device 100 may be either front-wired or rear-wired, many options may be available to mount the universal computer networking device 100 in a rack mount cage. For example, the universal computer networking device 100 may have brackets 40 near the first side 1, and have the power source 10 connecting into the second side 2. Many variations of bracket 40 positioning may be available, and may be orientated such that the universal computer networking device 100 resembles a front-wired arrangement, rear-wired arrangement, or a hybrid arrangement involving aspects of front-wired and rear-wired arrangements.

A method of making a universal computer networking device 101 universal may include providing a computer networking device having more than one power connection located on said computer networking device, wherein said computer networking device connects to a power source from either a first side or a second side of said computer networking device, attaching a power source to a first opening located proximate said first side of said computer networking device or to said second opening located proximate a second side of said computer networking device, and attaching a power source to one of said more than one power connection on either said first side or said second side. The method may further include placing a cover over one of said first opening or said second opening, swapping said power source for said cover to change a racking arrangement, providing a plurality of light emitting diodes on said first side and said second side, providing at least one console port on said first side and said second side, mounting at least two brackets on said computer networking device, providing a plurality of ground safety connections on said first side and said second side of said computer networking device, providing a plurality of Ethernet ports on said second side of said computer networking device.

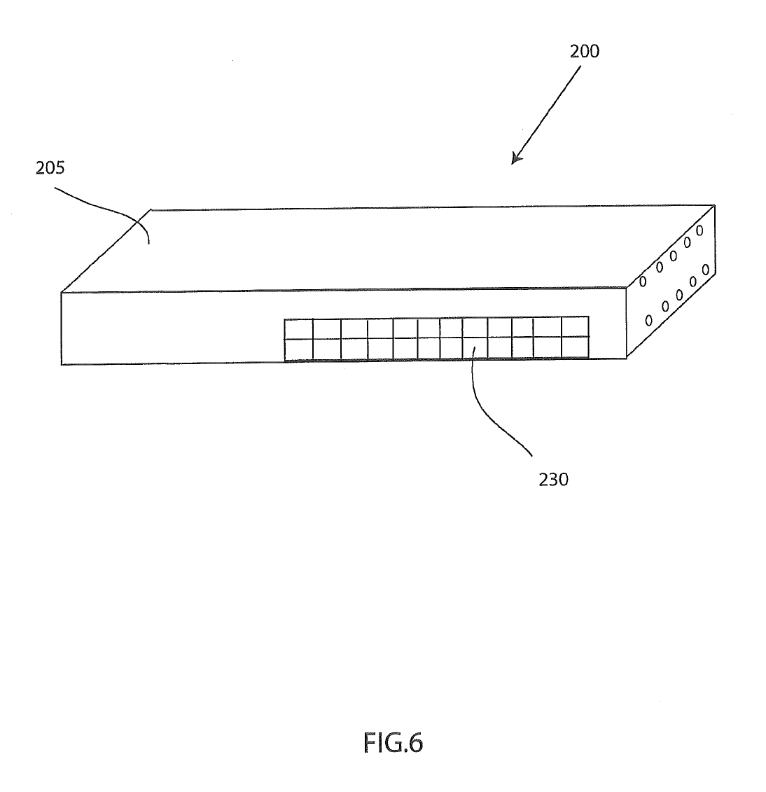

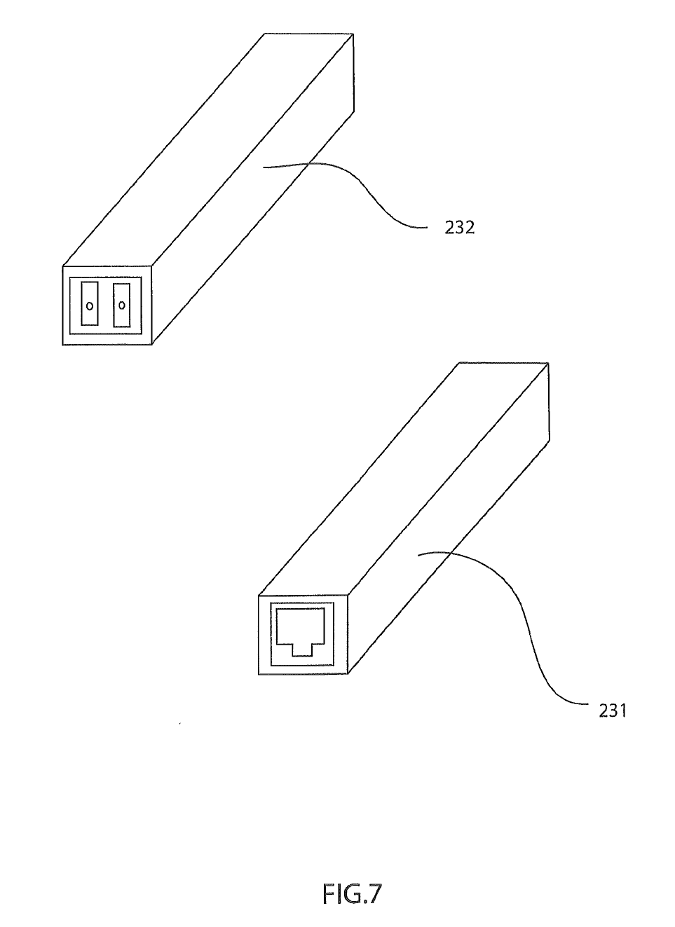

FIG. 6 depicts a computer networking device 200 having a plurality of small form factor pluggable ports 230 located on a chassis 205. Small form factor pluggable ports 230 may be referred to as SFP ports, and may be dimensioned similar to Ethernet ports. Furthermore, SFP may also be known as mini-GBIC. Thus, computer networking device 200 may have a plurality of SFP ports 230, each SFP port 230 receptive to either a Copper transceiver 231 or a Fiber-optic transceiver 232. FIG. 7 depicts an embodiment of both a copper transceiver 231 and a fiber-optic transceiver 232. The copper transceiver 231 may be a RJ45 connector. Moreover, both the copper transceivers 231 and the fiber-optic transceivers 232 may plug in and out of any SFP port 230. Thus, any transceiver entering a SFP port 230 may be detachable, replaceable, removably secured, and/or separable from the SFP port 230.

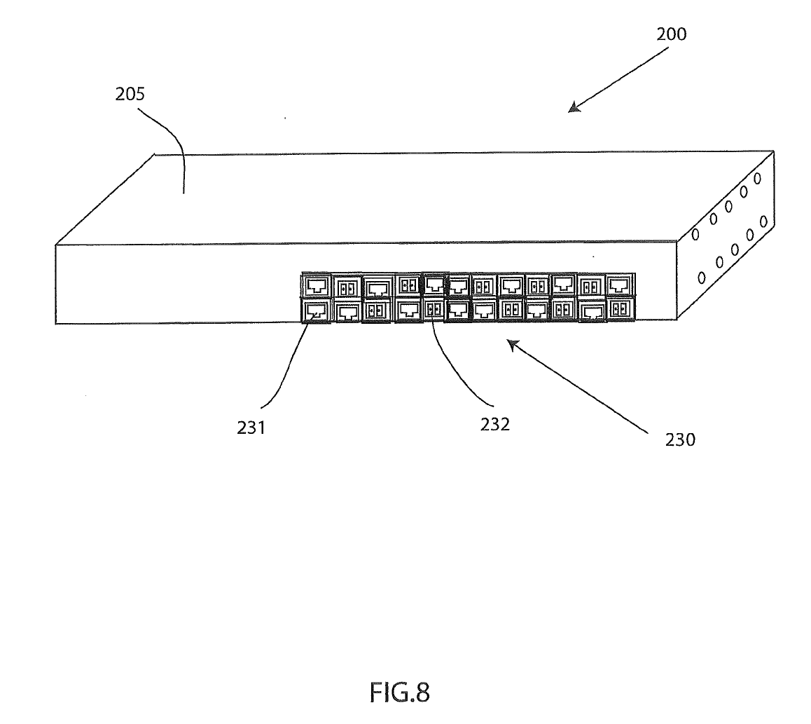

Because computer networking device 200 may have a plurality of SFP ports 230, it may accommodate a mix of copper transceivers 231 and fiber-optic transceivers 232, as depicted by FIG. 8. For example, computer networking device 200 may have 24 SFP ports 230 located on a chassis 205, wherein 12 of the 24 SFP ports being receptive to copper transceivers 231, and 12 being receptive to fiber-optic transceivers 232. It should be well understood that the ratio, arrangement, or mix, of copper transceivers 231 and fiber-optic transceivers 232 may be any ratio, arrangement, or mix that a consumer desires, and may be variable, adjustable, or dynamic. Thus, a manufacturer may build computer networking device 200 with a plurality of SFP ports 230, and may not have to pre-define the number of copper RJ45 ports versus fiber-optic ports. Furthermore, the ratio of copper to fiber-optic may be changed in the field, with relative ease and no disassembly of the chassis 5. Accordingly, computer networking device 200 offers per-port modularity.

Per-port modularity and all of its features may be incorporated by the universal computer networking device 100 and 101. For example, Ethernet ports 30 of universal computer networking device 101 may instead be SFP ports 230. Computer networking device 200 may be an industrial grade switch. Industrial, hardened, rugged, or a ruggedized computer networking device 200 may be designed to reliably operate in harsh operating environments and conditions, such as extreme heat or extreme cold, electromagnetic noise, electrical spikes and/or surges, power dropouts, high voltage, etc. To reliably operate in these extreme environments and under these conditions, computer networking device 200 may be sealed, may be designed to be water and moisture resistant, and may be very carefully and meticulously constructed to survive operation in extremely harsh environments. Disassembling and reassembling an industrial grade computer networking device 200 may require a great amount of precision, may compromise the integrity of the computer networking device 200 and may negatively affect the performance of the computer networking device 200 when operating in such harsh environments. Therefore, the ability to decide in the field the ratio of copper versus fiber-optic ports without disassembling the computer networking device 200 may be advantageous.

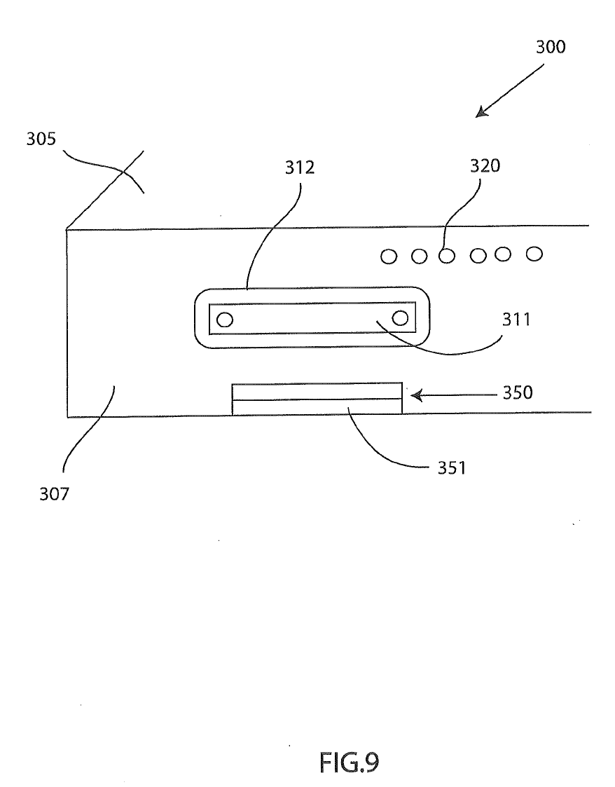

FIG. 9 depicts a computer networking device 300 having a slot 350 located on the face 307 of computer networking device 300, which may allow an insulator 355 to enter the internal body of computer networking device 300 to contact a ground finger 342 to break a ground connection 442. The slot 350 may be rectangular in shape, but may also be square, or other functional geometric shapes. In many embodiments, the slot 350 may be positioned below a power receptacle 312 on the face 307 of computer networking device 300. In other embodiments, the slot 350 may be positioned proximate a ground finger 342 within the chassis 305. In one embodiment, the slot 350 may be coplanar with a ground finger 342, or coplanar with a plurality of ground fingers 342. The slot 350 may also be referred to as an opening, aperture, access point, cut, hole, niche, slit, orifice, slash, or vent. The slot 350 may also be characterized as a rectangular opening in the chassis 305. Furthermore, the slot 350 may have a two-piece cover 351 to prevent dust, harmful particles, and debris from entering the internal body of the computer networking device 300. The two pieces of the cover 351 may fold or hinge inward when an insulator 355 is inserted into the slot 350 to allow access to the ground finger 342, and may return to its original coplanar position covering the slot 350. Other covers, such as removable covers, one piece covers, sliding covers, and plate-like covers may also be used.

Worldwide electrical and safety standards may require that many mains-operated devices, such as computer networking device 300, be subjected to high potential testing. A high potential test may involve high voltage, sometimes 500 V or more, placed on the power inputs for a length of time, sometimes a minute or more, to check if any shorts to ground are present. The high potential test may also be performed as part of a production test to verify that there may be no shorts between the high voltage power input circuit and the chassis 305. Chassis 305 may also be referred to as a case. Equipment may sustain a fault in its electric circuits, or the mains voltage may experience perturbations in excess of its nominal value. Thus, another purpose of a high potential test may be to ensure the sufficiency of dielectric isolation between the electrical circuits of the device, such as computer networking device 300, and the features of the device that may be accessible to users, such that these anomalies may become unlikely to result in shock or injury.

The same perturbations of line voltage that may cause injury to users of electrical equipment may be capable of causing damage to the electric circuits therein. Such circuits may be frequently supplied with electronic devices, or protective devices, such as metal-oxide varistors, transient-voltage suppressors, and spark gaps, to shunt, or divert, the perturbations to earth ground. In most embodiments, computer networking device 300 may contain protective devices in the internal body. These protective devices may clamp the voltage on the wires to a value that may be intrinsically safe to the internal circuits. This value may be less than the voltage applied during the high potential test. Thus, to perform a high potential test, the connection between the protective devices and earth ground may have to be broken. Upon completion of the high potential test, the connection between the protective devices and earth ground may have to be restored to ensure continued proper operation and safety of the electrical equipment.

Referring again to FIG. 9, it may be required that a high potential test be performed not only at the point of manufacture, but also upon installation of such electrical equipment, such as computer networking device 300. Therefore, it may be necessary that the ground disconnect means be accessible to technical personnel in the field at any location, and be unobtrusive as possible with respect to the integrity of the equipment. Slot 350 located somewhere on the chassis 305 of computer networking device 300 may provide the accessibility to perform the high potential tests both at the time of manufacture and in the field at a point after manufacture. Furthermore, the present invention may use a connecting means which is passively connected.

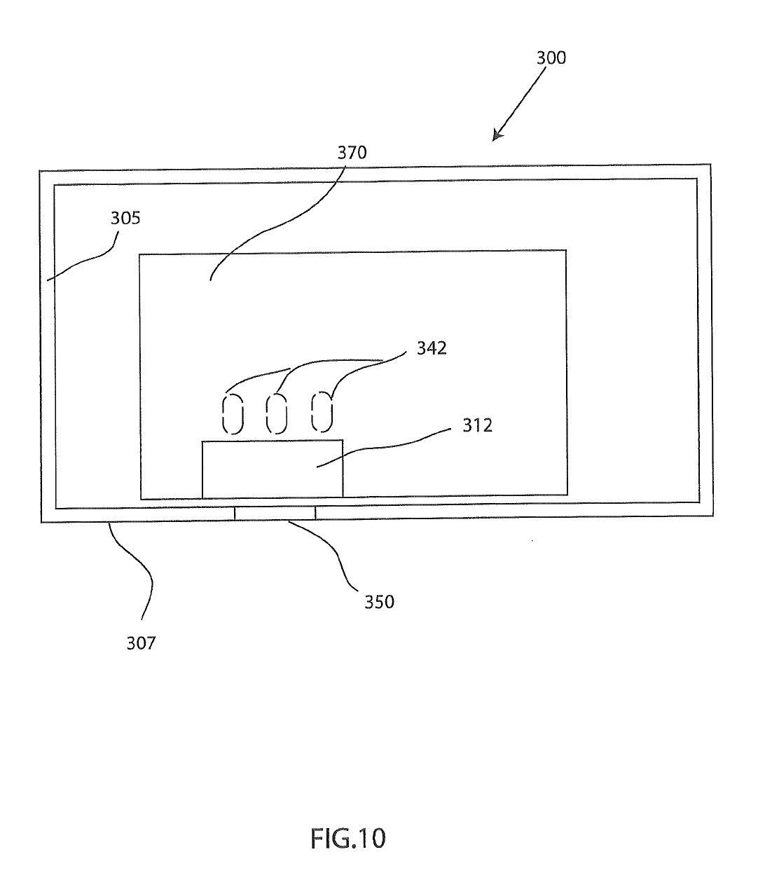

FIG. 10 depicts an embodiment of the locations of certain components of computer networking device 300. The power receptacle 312 may be positioned proximate the face 307, and proximate the printing circuit board (PCB) 370, wherein the power receptacle 312 may be receptive to a power source. The ground finger 342 may be positioned below the power receptacle 312 and on the underside of the PCB 370, as shown by the hidden lines. The ground fingers 342 may be a spring, a contact spring, a spring arm, biasing member, resilient member, or any semi-rigid conductive material that may exert a return or opposing mechanical force when dislodged from its original position at equilibrium. In many embodiments, the ground finger 342 may be a conductive material. In one exemplary embodiment, the ground finger 342 may be composed of beryllium-copper. Furthermore, there may be only one ground finger 343 present inside computer networking device 300, or there may be more than one ground finger 342.

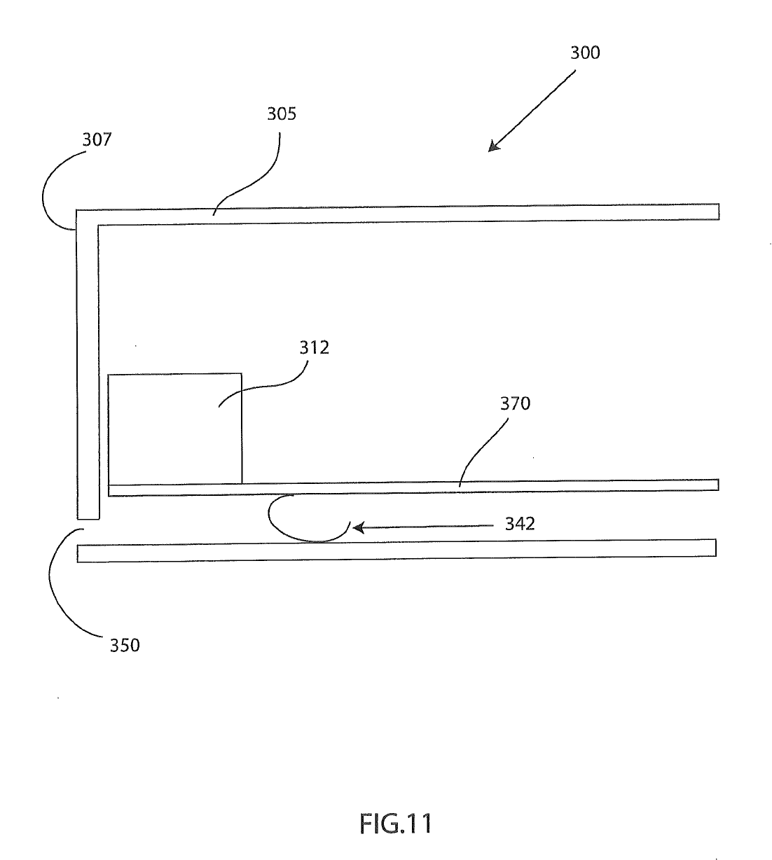

FIG. 11 shows computer networking device 300 during normal operating conditions, before a high potential test may be performed without risking damage to the internal protective circuits. The ground finger 342 may rest on the bottom surface of the chassis 305. The contact between the ground finger 342 and the chassis 305, in particular the bottom, inner surface of the chassis 305, may establish the connection between the protective devices and the ground. In one embodiment, the earth ground is the chassis 305, or metal case of computer networking device 300. While the ground finger 342 is in communication with the ground, the protective devices may perform their intended job, and prevent damage to the internal circuits if there is a surge, spike, transients, over-voltages, etc. applied. If a high potential test was performed under these conditions, the protective circuits may maintain a lower voltage level and protect the internal circuits of computer networking device 300. Therefore, to perform a high potential test on computer networking device 300, the connection between the protective circuits and the chassis 305 may be broken. During the normal operating conditions, slot 350 may be accessible, or have a cover placed over the slot 350.

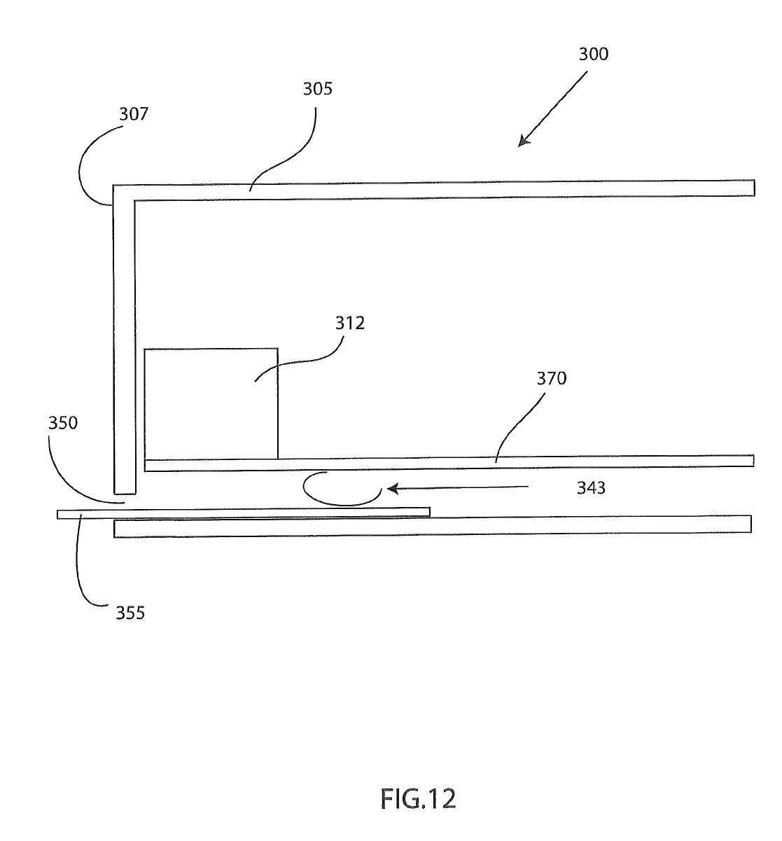

Referring now to FIG. 12, the connection between the protective circuits and the earth ground may be broken by dislodging the ground finger 342 to a position other than resting on or contacting the bottom surface of the chassis 305. To break this connection, an insulator 355 may be inserted into slot 350 to engage the ground finger 342 such that the ground finger 342 no longer contacts the bottom surface of the chassis 305. Specifically, the insulator 355 may be inserted, placed, stuck, guided, forced, introduced, jammed, slid, or put into the slot 350 such a distance to contact the ground finger 342, applying mechanical force on the ground finger 342. The mechanical force applied may be equal to the amount required to lift, move, dislodge, or vacate the ground finger 342 from touching the bottom surface of the chassis 305. This position is depicted as ground finger 343 in FIG. 12. Once the contact between the ground finger 342 and the bottom surface of the chassis 305 is interrupted, the protective circuits may no longer be grounded to the chassis 305, thus preventing any damage to the protective circuits if a high amount of voltage is introduced or inputted into the computer networking device 300, or any electronic device. Accordingly, a high performance test may be performed without damaging the protective circuits when the ground finger 342 does not contact the bottom surface of the chassis 305.

Once the high performance voltage test is completed, the insulator 355 may be removed from the computer networking device 300 through the slot 350. After the insulator 355 is removed, the ground finger 342 may return to its original position, contacting the bottom surface of the chassis 305 relying on the spring action of the ground finger 342. At this moment, the normal operating conditions may be restored, and the risk of incorrectly disassembling and/or reassembling the computer networking device 300 may be avoided because of the accessible slot 350 and the springing action of the ground finger 342, reestablishing the connection between the protective circuits and the chassis 305, or ground. This device and method may be referred to as a means of passive interconnection to ensure system integrity.

The insulator 355 may also be referred to as a planar object, card, or dielectric element. The insulator may be any dielectric material, such as plastic. The insulator 355 may be rectangular, or it may be square. In most embodiments, the insulator 355 may be dimensioned to fit within the parameters of the slot 350. For example, if the slot 350, or opening, has an area, A, than the insulator 355 may be dimensioned to fit within area, A, of the slot 350. The insulator 355 may be the size of a standard credit card; specifically, the surface area and perimeter of the insulator 355 may be the size of a standard credit card. Because of the convenient size of the insulator, a technician in the field may simply reach for a credit card from his or her persons and break the common connection between the earth ground and protective circuits. Moreover, the insulator 355 may be of a size such that when inserted into slot 350, a portion of the insulator 355 may extend outward from the face 307 of the computer networking device 300, allowing a technician to grab the insulator and remove, slide, dislodge, or pull the insulator 355 out of the slot 350.

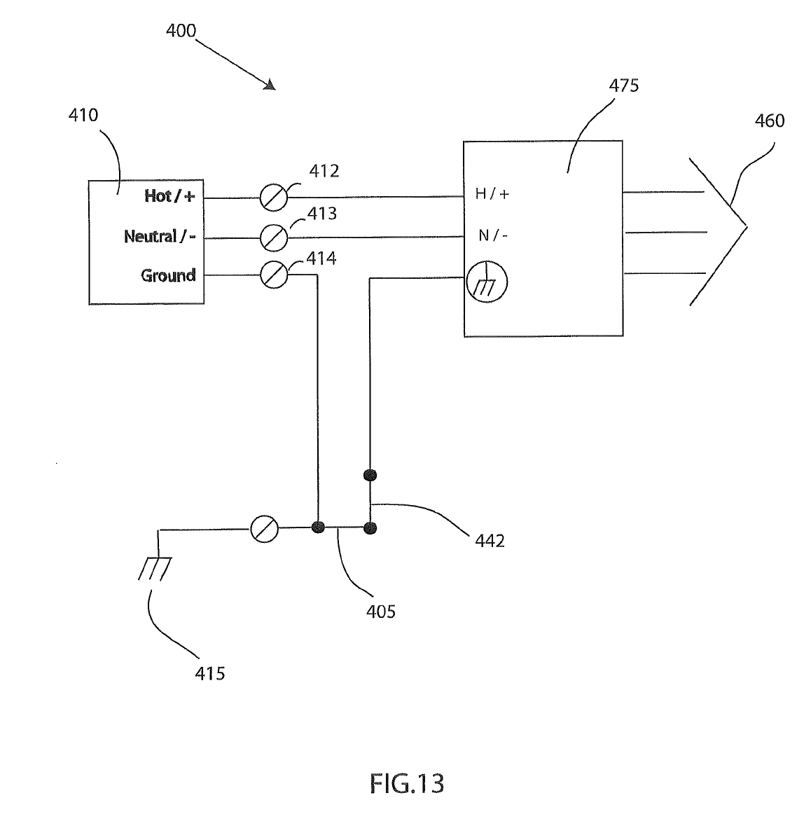

FIG. 13 depicts an embodiment of a circuit 400, while a computer networking device 300 is operating during normal conditions. Apparent in circuit system 400, chassis connection 405 is in electrical communication with the ground finger connection 442. During this state, the protective circuits may be functioning properly, and a high potential voltage test may not be performed without risking damage to the protective circuits. Moreover, circuit system 400 may have a raw input power source 410, inputting voltage to the computer networking device 300, and may exit circuit system 400 as clean and protected power 460.

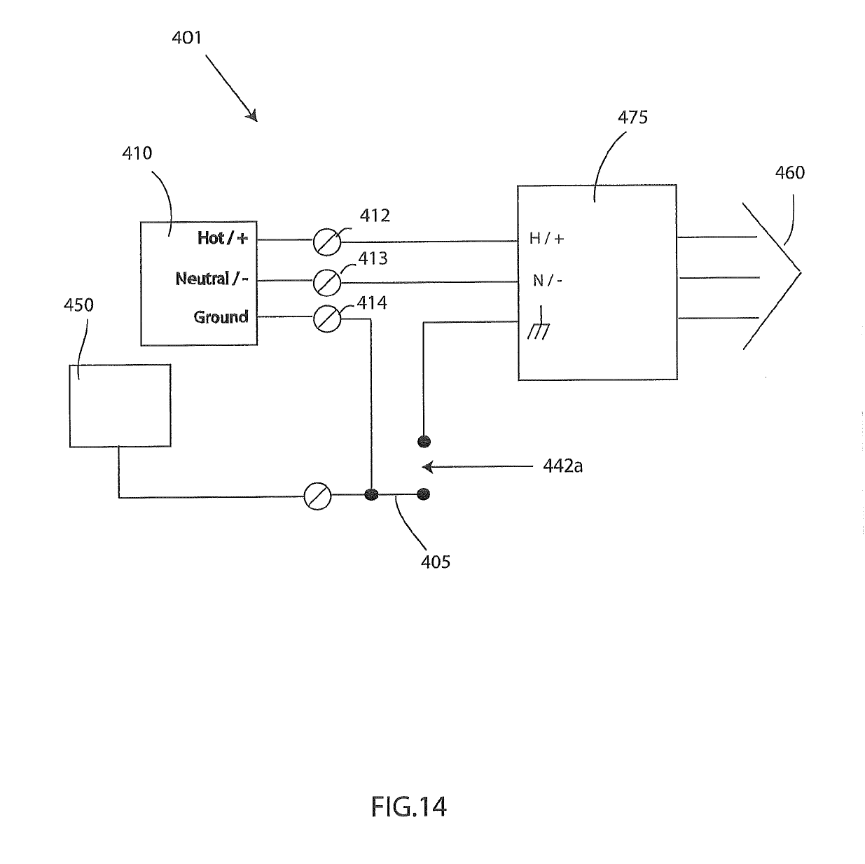

FIG. 14 depicts an embodiment of a circuit system 401, while a computer networking device 300 is prepared for a high potential voltage test. The difference between circuit system 400 and circuit system 401 is that the chassis connection 405 may no longer be in electrical communication with the ground finger connection 342. Accordingly, ground connection 442a may show that the connection has been broken. Thus, high potential tester 450 may apply a large amount of voltage to inputs 412, 413, 414 without risking damage to the protective circuits of a computer networking device 300.

A method of performing a high potential test may comprise the steps of providing a computer networking device having an opening on a face of the computer networking device, wherein the opening allows access inside the computer networking device, and a conductive resilience member located within the computer networking device, contacting a surface of the computer networking device, wherein contact between the conductive resilience member and the surface establish an electrical connection, positioning an insulator between the conductive resilience member and the surface of the computer networking device to break the electrical connection, sending a high amount of voltage into the computer networking device to test an internal circuit system, and removing the insulator. In accordance with this method, no disassembly of the computer networking device may be required. Furthermore, the dielectric element may engage the conductive resilience member to break the electrical connection.

The method of performing a high potential test may further include the steps of sliding the insulator through the opening, positioning the opening proximate a power receptacle, wherein the conductive resilience member is positioned between a printing circuit board and the surface of the computer networking device, disengaging a protective circuit of the computer networking device to prevent the protective circuits from clamping an applied voltage, and allowing access to the conductive resilience member.

It should be understood that universal computer networking device 100 and 101 may incorporate features discussed in reference to computer networking device 300, including a slot 350 located on a first side 1 or second side 2 of universal computer networking device 100. For example, universal computer networking device 100 may have a slot 350 located proximate a first opening 16. Furthermore, computer networking device 300 may incorporate features of universal computer networking device 100, such as having LEDs 320 on both sides of computer networking device 300. Furthermore, computer networking device 300 may include SFP ports 230. Computer networking device 300 may also be an industrial grade switch and/or industrial grade switch mount, having the same features of industrial grade switches discussed supra.

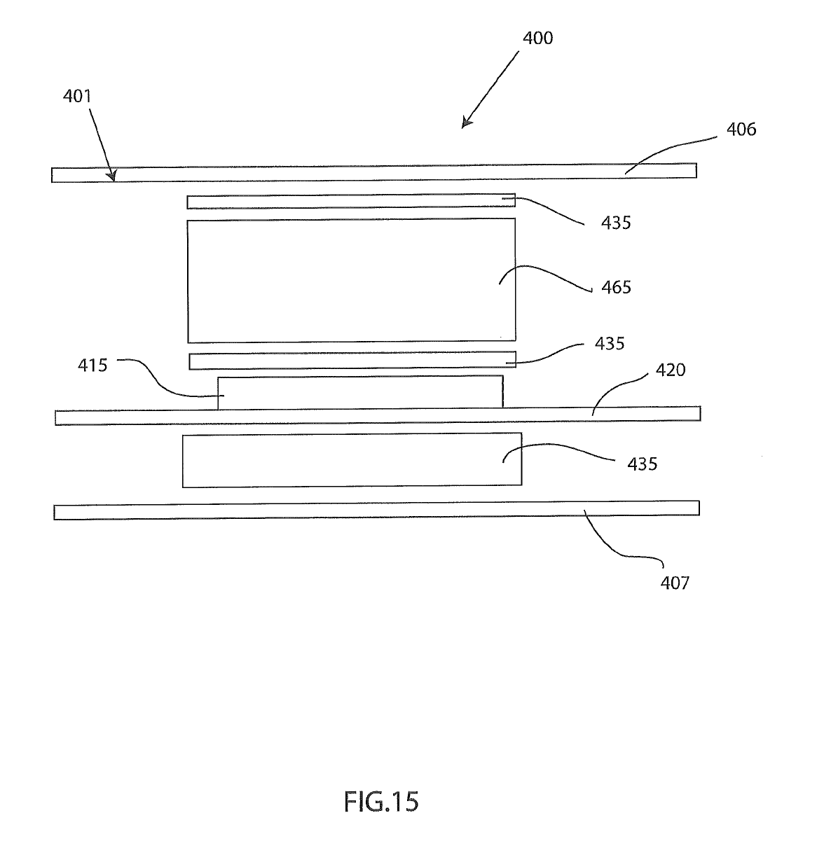

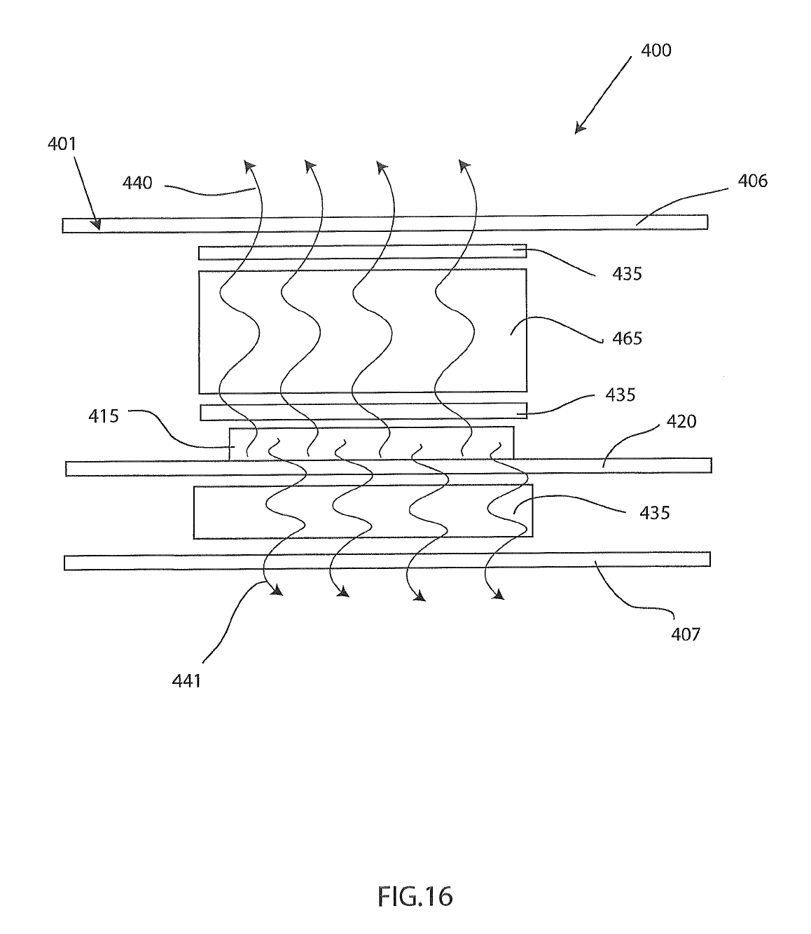

FIG. 15 depicts an embodiment of heat transfer system 400 inside a computer networking device 401; specifically, a heat transfer system 400 positioned between a cover 406 and a base 407 of the computer networking device 401. The heat transfer system 400 may include one or more thermal pads 435, one or more heat sinks 465, and a hot component 415 mounted on a printing circuit board 420. The heat transfer system 400 may transfer, dissipate, and conduct heat away from the hot component 415 in both directions, as shown in FIG. 16. Specifically, the heat transfer system 400 may conduct heat away from the hot component 415 on both sides of the printing circuit board 420. Having a heat transfer system 400 inside a computer networking device 401 may result in better heat transfer to the cover 406 and base 407, thus lowering the temperature of the hot component 415 and extending operating life of computer networking device 401.

In industrial applications, network switch 401 may comprise as few moving parts as possible because moving parts may make it more likely to fail from vibration, shock, temperature variations, dust build-ups, etc. In many embodiments of computer networking device 401, no fans are present within the internal body to cool down internal temperature. Furthermore, heat from hot component 415 may be dissipated via natural convection, conduction, and/or radiation. Convection is where a common computer networking device has ventilation slots allowing air to pass through. However, in industrial applications, vents may not be desirable because they can let dust and/or other contaminants into the computer networking device 401. Moreover, vents placed on the sides of computer networking device 401 may negatively affect natural air convection. Conduction is where the heat is transferred away from the hot component 415 through physical contact. In many embodiments, heat sinks 465 may be used to conduct heat away from a hot component. Therefore, the heat transfer system 400 may increase heat transfer away from a hot component 415 through conduction and radiation, without sacrificing the integrity of the computer networking device 400. In an exemplary embodiment, computer networking device 401 may be an industrial grade Ethernet switch.

Referring again to FIGS. 15-16., a hot component 415 may be soldered or mounted with other known means to a printing circuit board 420. The hot component 415 may be any part, component, or device located within the computer networking device 400 which emits a certain amount of heat. The printing circuit board 420 may be mounted somewhere between the cover 406 and the base 407 of computer networking device 401. The cover 406 and base 407 may be part of the case; the case may be the structural enclosure of the computer networking device 401. The case may be made out of metal. In one embodiment, the case may be aluminum.

The hot component 415 mounted on the printing circuit board 420 may have a combination of heat sinks 465 and thermal pads 435 in communication with each other that may extend to the cover 406. In an exemplary embodiment, a thermal pad 435 is in direct communication with the top of the hot component 415, located above the printing circuit board 420. Furthermore, a heat sink 365 may also be located above the printing circuit board 420, wherein the heat sink 465 may be in direct communication with the thermal pad 365 which is in direct communication with the hot component 415. Also, above the printing circuit board 420 and proximate the cover 406 may be an additional thermal pad 435. The positioning of these thermally conductive devices may conduct heat emitted by the hot component 415 upwards and away from the hot component 415 towards the cover 406, and eventually out into the ambient air. The arrangement of the heat sink 465 and thermal pads 435 may vary. For example, a heat sink 465 may be in direct communication with the hot component 415 and have a thermal pad 435 above. The combination of heat sinks 465 and thermal pads 435 may increase heat transfer away from the hot component 415.

Another combination of heat sink 465 and thermal pad 435 may be positioned underneath the printing circuit board 420. In one embodiment, a heat sink 465 may be in direct communication with the underbelly of the printing circuit board 420 to conduct heat away from the hot component towards the base 407. In another embodiment, a thermal pad 435 may be in direct communication with the underbelly of the printing circuit board 420 to conduct heat away from the hot component 415 towards the base 407. Furthermore, another heat sink 465 or thermal pad 435 may be in direct communication with the heat sink 465 or thermal pad 435 that is in direct communication with the printing circuit board 420. This combination or series of thermally conductive devices may extend to the base 407. Moreover, direct communication as used with respect to the arrangement of the components of computer networking device 401 may be actual physical contact, or simply fluid communication, wherein the components are spaced apart a small distance from each other.

Accordingly, a hot component 415 may be sandwiched between thermally conductive devices to conduct heat away in both directions 440, 441. For example, the heat emitted by the hot component is conducted through a heat sink 465 and thermal pad 435 combination towards the cover 407 (top) or the base 407 (bottom). The direction of the transferred heat 440 towards the cover 406 and the direction of the transferred heat 441 towards the base 407 are depicted in FIG. 16. When the heat reaches the cover 406 and the base 407, the heat may be absorbed and dispersed or spread out across the larger surface areas of the cover 406 and the base 407. After the heat is absorbed and dispersed, the heat may then radiate to the air outside the case.

To maximize the heat transfer, the thermal pads 435 may be as thin as possible. The heat sinks 465 may be solid aluminum, or any other metal with similar thermal conductivity. Additionally, thermal pads 435 may be used between all component-to-heat sink, printing circuit board-to-heat sink, and heat sink-to-case contacts to increase the contact area. Using thermal pads 435 between these contacts may wet the area. Wetting theses contacts may be advantageous because direct hard surface-to-hard surface contacts may offer poor thermal transfer due to microscopic imperfections in the surface. Introducing thermal pads 435 to areas within the computer networking device 401 such as contacts between hard surface-to-hard surface may expand the possible contact area, wherein heat may be conducted.

It should be understood that universal computer networking device 100 and 101 may incorporate features discussed in reference to computer networking device 401. For example, universal computer networking device 100 and 101 may have a heat transfer system 400 located inside chassis 5. Furthermore, computer networking device 401 may include features discussed with respect to the universal computer networking device 100. For example, computer networking device 401 may have more than one power connection 15 located on the front or back of computer networking device 401. Additionally, computer networking device 401 may also have SFP ports 230, and incorporate per-port modularity of computer networking device 200.

Various modifications and variations of the described devices and methods will be apparent to those skilled in the art without departing from the scope and spirit of the invention. Although this invention has been described in connection with specific embodiments, outlined above, it should be understood that the invention should not be unduly limited to such specific embodiments. Various changes may be made without departing from the spirit and scope of the invention.

What is claimed is:

1. A device comprising:
a computer networking device having more than one power connection located on said computer networking device, wherein said computer networking device connects to a power source from either a first side or a second side of said computer networking device.

2. The device of claim 1, wherein said power source communicates with said computer networking device through a detachable pluggable unit.

3. The device of claim 1, wherein said computer networking device has more than one opening capable of accepting said power source.

4. The device of claim 2, wherein said detachable pluggable unit occupies one of said more than one opening.

5. The device of claim 1, wherein a cover is placed over one of said more than one power connection.

6. The device of claim 1, wherein a bracket system is mounted on said computer networking device.

7. The device of claim 4, wherein at least two brackets mounted on said computer networking device have a plurality of orientations.

8. The device of claim 4, wherein said bracket system employs universal EIA/WECO/ETSI mounting holes.

9. The device of claim 1, wherein said computer networking device receives power from only of said more than one power connection while operating.

10. The device of claim 1, further comprising:
a plurality of light emitting diodes located on said first side and said second side;
a plurality of ground safety connections located on said first side and said second side; and
at least one console port located on said first side and said second side.

11. The device of claim 1, wherein said computer networking device is an Ethernet switch.

12. The device of claim 1, wherein said computer networking device is an industrial grade Ethernet switch.

13. A universal computer networking device device comprising:
a first opening located proximate a first side of a chassis, said first opening receptive to a power source;
a second opening located proximate a second side of said chassis, said second opening receptive to a power source.

14. The device of claim 12, further comprising:
a cover placed over one of said first opening or said second opening;
wherein swapping said cover with said power source changes a mounting orientation of said chassis; and
at least two brackets affixed to said chassis.

15. The device of claim 1, wherein said power source is a detachable plug having a wire attached to one end of said detachable plug, wherein said wire supplies power.

16. The device of claim 12, wherein a plurality of light emitting diodes are located on a first side and a second side.

17. The device of claim 12, wherein a set of receptors located on an inner surface of said first opening and said second opening directly connect to a power source.

18. The device of claim 12, wherein a at least one console port is located on said first said and said second side

19. The device of claim 12, wherein a plurality of Ethernet ports are located on said second side.

20. The device of claim 12, wherein a plurality of small form factor pluggable ports is located on said second side.

21. The device of claim 12, wherein a cover is placed over one of said first opening or said second opening.

22. The device of claim 12, wherein said chassis is an Ethernet switch.

23. The device of claim 12, wherein said chassis is an industrial grade Ethernet switch.

24. The device of claim 13, wherein said at least two brackets are positioned in a plurality of orientations to allow for adjustable mounting.

25. The device of claim 13, wherein said at least two brackets have a universal EIA/WECO/ETSI mounting hole.

26. A method of making a computer networking device universal comprising:
providing a computer networking device having more than one power connection located on said computer networking device, wherein said computer networking device connects to a power source from either a first side or a second side of said computer networking device; and
attaching a power source to a first opening located proximate said first side of said computer networking device or to said second opening located proximate a second side of said computer networking device.

27. The method of claim 23, further comprising:
placing a cover over one of said first opening or said second opening; and
swapping said power source for said cover to change a racking arrangement.

28. The method of claim 23, further comprising:
providing a plurality of light emitting diodes on said first side and said second side;
providing at least one console port on said first side and said second side;
mounting at least two brackets on said computer networking device;
providing a plurality of ground safety connections on said first side and said second side of said computer networking device; and
providing a plurality of Ethernet ports on said second side of said computer networking device.

29. The method of claim 19, wherein said computer networking device is an industrial grade Ethernet switch.

30. The method of claim 20, wherein said at least two brackets have a plurality of orientations to allow for adjustable positioning.

31. The device of claim 24, wherein said at least two brackets have a universal EIA/WECO/ETSI mounting hole.

32. A device comprising:
a plurality of small form factor pluggable ports located on a chassis, said ports being receptive to both a removable copper transceiver and a removable fiber-optic transceiver;
wherein an arrangement of said removable copper transceiver and said removable fiber-optic transceiver includes an adjustable ratio of said removable copper transceivers to said removable fiber-optic transceivers.

33. The device of claim 30, wherein said plurality of small form factor pluggable ports accommodates said removable copper transceivers.

34. The device of claim 30, wherein said plurality of small form factor pluggable ports accommodates said removable fiber-optic transceivers.

35. The device of claim 30, wherein said chassis is a computer networking device.

36. The device of claim 33, wherein said computer networking device is an industrial grade network switch.

37. A device comprising:
a computer networking device having an opening on a face of said computer networking device, wherein said opening allows access inside said computer networking device;
a conductive resilience member, located within said computer networking device, contacting a surface of said computer networking device, wherein contact between said conductive resilience member and said surface establish an electrical connection; and
wherein an insulator engages said conductive resilience member, breaking said electrical connection.

38. The device of claim 36, wherein said computer networking device is an industrial grade Ethernet switch.

39. The device of claim 36, wherein said insulator enters through said opening.

40. The device of claim 36, wherein said opening is located proximate said power receptacle.

41. The device of claim 26, wherein said opening allows access to said conductive resilient member.

42. The device of claim 36, wherein said conductive resilience member is a ground finger.

43. The device of claim 42, wherein said ground finger is made of copper.

44. The device of claim 36, wherein said opening is a rectangular.

45. The device of claim 36, wherein said conductive resilience member is located on the underside of a printing circuit board, further wherein said printing circuit board is located proximate said opening.

46. A device comprising:
an electrical circuit with a local common connection, said common connection being electrically common to a ground;
a spring member in electrical communication to said common connection, wherein an opposite end of said spring member is in mechanical communication with said earth ground, establishing an electrical communication between said spring member and said ground;
a slot providing access to said spring members, wherein a dielectric element inserted through said slot breaks said electrical communication.

47. The device of claim 1, wherein said slot is rectangular.

48. The device of claim 1, wherein said opposite end of said spring member is in mechanical communication with a bottom surface of a chassis.

49. A method of performing a high potential test comprising:
providing a computer networking device having an opening on a face of said computer networking device, wherein said opening allows access inside said computer networking device, and a conductive resilience member located within said computer networking device, contacting a surface of said computer networking device, wherein contact between said conductive resilience member and said surface establish an electrical connection;
positioning an insulator between said conductive resilience member and said surface of said computer networking device to break said electrical connection;
sending a high amount of voltage into said computer networking device to test an internal circuit system; and
removing said insulator.

50. The method of claim 48, wherein no disassembly of said computer networking device is required.

51. The method of claim 48, wherein said dielectric element engages said conductive resilience member to break said electrical connection.

52. The method of claim 49, wherein said insulator is a dielectric element.

53. The method of claim 49, further comprising:
sliding said insulator through said opening;
positioning said opening proximate a power receptacle; and
wherein said conductive resilience member is positioned between a printing circuit board and said surface of said computer networking device.

54. The method of claim 49, further comprising:
disengaging a protective circuit of said computer networking device to prevent said protective circuits from clamping an applied voltage; and
allowing access to said conductive resilience member.
